(19) United States
(12) Patent Application Publication
(10) Pub. No.: US 2018/0159682 A1
(43) Pub. Date: Jun. 7, 2018

(54) DISTRIBUTED LEDGER

(71) Applicant: CAVENDISH WOOD LIMITED, Cheshire (GB)

(72) Inventors: Chris Futcher, Cheshire (GB); Kurt Farrar, Cheshire (GB); Daniel Harris, Cheshire (GB)

(73) Assignee: CAVENDISH WOOD LIMITED, Cheshire (GB)

(21) Appl. No.: 15/830,865

(22) Filed: Dec. 4, 2017

(30) Foreign Application Priority Data
Dec. 2, 2016 (GB) GB 1620546.0

(51) Int. Cl. H04L 9/06; H04L 29/08; G06Q 20/06; H04L 29/06

(52) U.S. Cl. CPC H04L 9/0637; H04L 63/0428; G06Q 20/065; H04L 67/1042

(57) ABSTRACT

A system for processing information is provided. The system comprises a storage module for hosting a first ledger, and a processing module, wherein the processing module is configured to: receive a data entry from a client stored remotely of the processing module, process the data entry to form one or more keys relating to the data; and store the one or more keys in the first ledger and distribute the one or more keys to a second ledger stored remotely of the storage module. Also provided is a corresponding method of processing data.

### Field of the invention

The present invention relates to a system for processing information. Particularly, but not exclusively, the present invention relates to a distributed network comprising of ledgers for maintaining and validating entries on a split distributed ledger.

### BACKGROUND OF THE INVENTION

There is often a lack of trust in proceedings in which documents must be securely stored and protected. Documents can be tampered with to fraudulently alter content or properties. Currently trust can be established with the inclusion of a neutral third party into proceedings. This third party will catalogue all documents and agreements to mediate between the original parties. This is a cumbersome process where access to the third party limits when any advancement can be made, thus greatly lengthening procedures. It is desirable to introduce this trust in said procedures without a third party being required to mediate.

Examples where this is a major issue could be legal evidence bundles, contracts, insurance, mergers and acquisitions. An improved method to carry out this process is required.

It is known that a distributed ledger, such as the one utilised in the crypto currency Bitcoin, can create immutable records of transactions which are shared across a distributed network in a blockchain data file. Once verified these transactions become near impossible to modify or remove from the ledger, requiring a vast number of entries to be modified at a vast number of locations simultaneously if the change is to take effect. The more entries added after a particular one in the chain the more difficult it becomes to alter said entry.

The addition of a single valid entry on the Bitcoin blockchain can however take on average 15 to 20 minutes with the current length of the blockchain; this time will only increase along with the length of the blockchain. A further limit to the Bitcoin system is that the addition of transactions to the ledger is limited to seven per second.

The Bitcoin white paper (Nakamoto, S., 2008. Bitcoin: A peer-to-peer electronic cash system) discloses the process of a secure peer-to-peer network in which crypto currency transactions are stored in a single blockchain.

The invention was made in this context.

### SUMMARY OF THE INVENTION

Embodiments of the present invention aim to provide an improved system in which records of data can be stored in an immutable form on a split distributed ledger and where said ledger can be used to easily verify that no alterations have been made to data or related properties. Embodiments of the present invention also aim to provide a faster system than existing blockchain solutions could provide in terms of both verification and addition of data.

According to an aspect of the present invention there is provided a system for processing information, comprising: a storage module for hosting a first ledger, and a processing module, wherein the processing module is configured to: receive a data entry from a client stored remotely of the processing module, process the data entry to form one or more keys relating to the data; and store the one or more keys in the first ledger and distribute the one or more keys to a second ledger stored remotely of the storage module.

The storage module of the system may also be arranged to store one instance of the first ledger, Which is a global ledger, and the processing module may be further configured to receive data from a plurality of instances of the second ledger, which are client ledgers; wherein the plurality of client ledgers may be categorised into sets dependent on a client.

By utilising a split in the distributed ledger there are great advantages, in terms of performance and security, over a single public distributed ledger as seen in the Bitcoin system.

The split in the distributed ledger means that the storage means does not have to store a copy of the entire ledger which, like the blockchain, is a file continuously increasing in size.

Existing solutions require every storage means present in the network to have a copy of a ledger containing every data entry, therefore wasting resources storing data irrelevant to the user providing the storage means. The split of the distributed ledger means that a user is only storing files in their storage means that they own, saving valuable processing and storage resources. The split of the distributed ledger however does not mean that the data is less secure since the global ledger, present in embodiments of the invention, stores all keys relating to the data so that data immutability is ensured.

Another result of the split distributed ledger is that the distributed ledger technology is opened up to many sectors where confidentiality of the information stored is of paramount importance. Medical agencies can use the system to store results from medical trials in a secure manner and ensure that the data can be checked by regulators. Regulators such as the Food and Drug Administration (FDA) and the Association of the British Pharmaceutical Industry (ABPI) can ensure that no aspect of the data has been tampered with since its addition to the split distributed ledger by the verification of the stored keys. Insurance providers may also use the split distributed ledger to ensure that an immutable record of all covered items exists to prevent against fraudulent claims, this can be completed without sharing customer's personal information with every user in the system. These are simply two of the cases where a standard distributed ledger would not be suitable, the invention however is not to be limited to these fields.

The content, whilst being able to be checked, cannot be recreated from the global ledger by other clients on the system, the global ledger could store a hash of a document, meta data, properties or even pointers to the document itself; this data could be stored in raw or encrypted form such as AES256.

In-memory caching of the client data enables high performance querying of the data stored, existing solutions cannot effectively utilise caching of data due to the size of the single ledger in use.

The present invention may also have scalability advantages over the existing solutions. This is due to the reduced size of data in global ledger. This reduced amount of information contained in the ledger means that the system can be expanded without dramatic effect to its operation.

The processing module may be further configured to access a plurality of a third category of ledgers hosted remotely of the storage module, wherein the third category of ledger is an asset ledger utilised for version tracking of a data entry.

The processing means could be further arranged to replicate the client and asset ledgers on a plurality of nodes associated with the client in a peer-to-peer network, where the global ledger may be accessible to every node in the plurality of nodes contained in the peer-to-peer network.

The processing means of the system may be arranged to add a data entry to one client ledger in the plurality of client ledgers; wherein the processing means may generate the key by using a cryptographic hashing algorithm and can verify the process at all client ledgers in the set. The cryptographic hashing algorithm may compute the key as a hash value from a combination of the received data entry and the previously generated hash values.

The processing module in the system wherein upon the identification of a corrupted client ledger may reconstruct said corrupted client ledger from an uncorrupted client ledger in the same set.

According to another aspect of the present invention there is provided a method of processing information, comprising: hosting a first ledger; receiving a data entry from a client; processing of data to form one or more keys; and storing the one or more keys in the first ledger and distributing the one or more keys in a second ledger hosted remotely.

The processing of the data may be that of a cryptographic hashing algorithm that utilises the received data entry and previously generated keys as inputs.

Through providing a method of processing information which allows for a distributed ledger to be split into multiple ledgers, the processing and storage requirements of a distributed ledger system can be reduced whilst maintaining the immutability benefits of the distributed ledger system.

### BRIEF DESCRIPTION OF THE DRAWINGS

Embodiments of the invention will now be described, by way of example, with reference to FIGS. 1 to 5 of the accompanying drawings, in which:

FIG. 1 illustrates an example of a split distributed ledger utilised in an embodiment of the present invention;

FIG. 2 shows a block diagram of the components of the system according to an embodiment of the present invention;

FIG. 3 shows a block diagram of a network implementing the concept of a split distributed ledger according to an embodiment of the present invention;

FIG. 4a and 4b detail the addition of data and a node to a client group in the split distributed ledger system according to an embodiment of the present invention;

FIG. 5 details a flowchart showing the steps in the method in which keys are stored in the ledgers after addition of a new data entry from a client according to an embodiment of the present invention.

### DETAILED DESCRIPTION

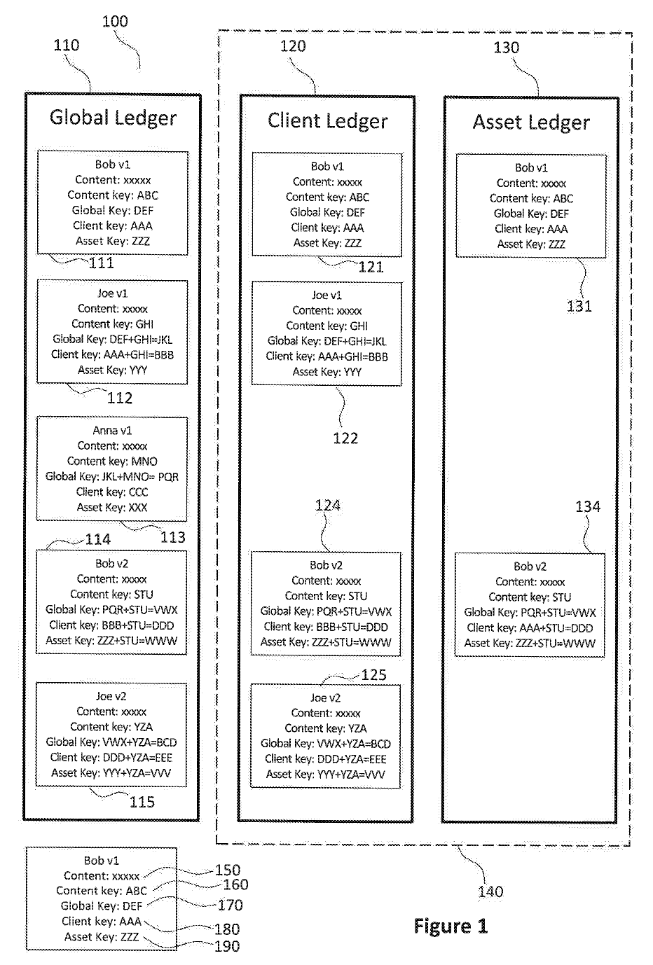

With reference to FIG. 1, the split distributed ledger 100 is detailed according to one embodiment of the present invention. The split distributed ledger 100 may comprise of three types of ledgers: the global ledger 110, the client ledger 120 and the asset ledger 130. Although it should be noted that the split distributed ledger 100 is not limited to comprising of three ledgers, embodiments may exist where the split distributed ledger 100 comprises of only two ledgers or a multiplicity of ledgers with no upper limit.

The global ledger no may be stored in a central storage means, which may be cloud based, and can be accessed by all clients. The client ledger 120 and asset ledger 130 may be stored remotely of the central storage means and may be replicated across multiple remote storage means. The client ledger 120 and asset ledger 130 are specific to one client group 140 many client groups 140 may exist within the split distributed ledger 100.

Each ledger may consist of a number of data entries 111-115, 121-125 and 131-134 which may contain content 150 and/or a plurality of keys 160-190; data entries may consist of information pertaining to but not limited to medical trials, records of insurance or legal documents. The number of keys 160-190 present in each data entry corresponds to the number of split ledgers in the system. The keys 170-190 for each data entry are generated from a combination of the content key 160 and the corresponding key 170-190 190 from the previous entry. The first entry in the ledger cannot be linked to any previous entries and therefore has a set of initial keys.

A processing module allows for the generation of keys 160-190 between the data entries in the global ledger 110, client ledger 120 and asset ledger 130, These keys 160-190 are transmitted to the client ledgers 120 and asset ledger 130 when a new entry is added.

In some embodiments, global keys 170 are generated from the combination of the content key 160 and the global key 170 from the previous entry in the global ledger. Client keys 180 are generated from the combination of the content key 160 and the client key 180 from the most recent entry in the relevant client ledger 120. Asset keys 190 are generated from the combination of the content key 160 and the asset key 190 from the most recent entry in the relevant asset ledger 130. In other embodiments keys of the current data entry are linked to the previous data entry.

This process links each data entry to all of the previous data entries in the ledgers, thus to alter one specific entry all subsequent entries in the ledgers must also be altered. Another layer of security is that these records need to be altered simultaneously across multiple instances of the ledgers, should one instance disagree with the others then the alteration to the ledger does not take effect. This makes any entry onto the split distributed ledger immutable once any entry is subsequently added to the global ledger.

In some embodiments, the method in which the keys 160-190, referred to as a hash for these embodiments, may be generated from the data is to use a cryptographic hashing algorithm. The input to this algorithm consists of the content hash of the current entry 160 and the relevant hash 170-190 generated from the previous data entry. The hashing algorithm applies a formula to the inputs so that a hash of a fixed size which represents the original data is generated. The algorithm is a one-way function meaning it is computationally infeasible to invert the process and calculate the input from the hash 160-190. However, should the user have access to the original input data, verification of the hash 160-190 can be carried out by re-computing and matching the two hash values against each other. The hash 160-190 generated by the algorithm must change substantially with any small change in the original data so the output of the slightly changed data appears to be uncorrelated with the output of the original data. The intricacies of cryptographic hashing algorithms will not be disclosed as they are considered to be part of the general knowledge to a person skilled in the art.

According to other embodiments, the method in which the keys 160-190 of the data may be generated is a block cipher. A block cipher allows for the data to be encrypted by the use of a cipher of the data combined with the previous ciphertext to create a ciphertext for new entry. This method links each new data entry to all previous data entries.

The specific key generating methods described in the embodiments above may be used, however the process is not limited to those methods described and any suitable method of generating a key 170-190 from a current content key 160 and a past key 170-190 may form an alternate embodiment.

As detailed in the embodiment in FIG. 1, the global ledger 110 contains the most data entries 111-115, with the client ledger 120 containing a subset of those data entries 121-125 which relate to a single client group 140 and the asset ledger 130 containing a further subset 131-134 of the entries in the client ledger 120 relating to a single document in the client group 140. The client group 140 shown in FIG. 1 owns the data entries 111, 112, 114 and 115 within which document 114 is an updated version of 111 and document 115 is an updated version of document 112. These links can be seen by the entries present in each of the three ledgers and in the previous keys 170-190 used as inputs in the calculations of the keys 170-190 for each entry. The remaining data entry 113 in the global ledger 110 relates to a different client group 140 and therefore different client ledgers 120 and asset ledgers 130 than detailed in FIG. 1. Similarly the remaining data entries 122 and 125 in the client ledger 120 relate to a different asset and therefore a different asset ledger 130 than detailed in FIG. 1.

The client key 180 and asset key 190 can be used to independently verify the client ledger 120 and the asset ledger 130 specific to one client group 140. A greater level of security is added with the global key 170 which links data from all clients groups 140 together in the global ledger. The added security comes from the quantity of data in the system. In the global ledger client 1's entry will be linked to the previous entry by any client, in an example embodiment this could be client 2. This linking prevents client 2 from altering their most recent entry even though it is not linked to another entry in their client ledger 120. This is due to its global key 170 being used as an input in the calculation of the global key of client 1's latest entry providing a level of verification higher than the client ledger. This is further exemplified in the asset key 190 and asset ledgers 130 where the same process applies hut with the client ledger and key forming the higher level verification. The processing module may perform these operations in the form of a RESTful API.

It is contemplated that replicating the client ledger across multiple nodes improves security due to the extra data which must be simultaneously altered in an attack. Another advantage is that corrupted files have no effect on the system as they may be recreated from an existing node in the client group 140 which contains the uncorrupted form. The global ledger 110, of which only one is required for operation, may be also be replicated on multiple storage means so as to protect against corruption of data.

In some embodiments if a client group 140 is removed from the system 100, the data entries relating to that client remain in the global ledger 110, due to the requirement of the keys to validate all subsequent entries in the global ledger 110. In these embodiments a removed client does not have to consider data protection or the security of their information since it cannot be recreated. The only change when a client group is removed is that the client ledgers 120 pertaining to that client group 140 cease to exist on the system 100 and therefore cannot add new data entries.

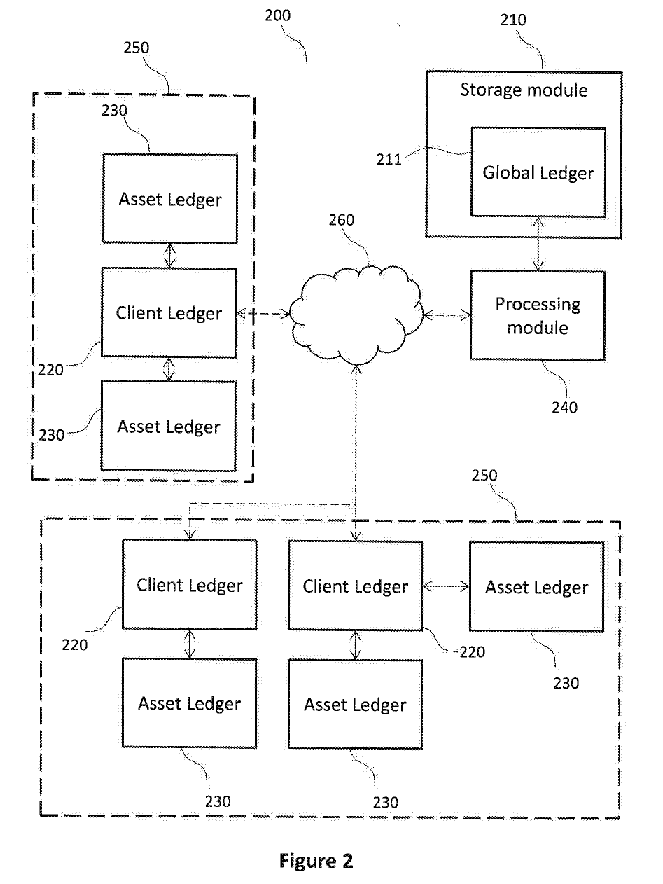

FIG. 2 details one embodiment of the structure of the main components of a system 200 implementing the embodiment of the split distributed ledger detailed in FIG. 1. In the present embodiment the system comprises: storage module 210, global ledger 211, client ledgers 220, asset ledgers 230, processing module 240, client groups 250 and a network 260.

The storage module 210 contains the global ledger 211, the global ledger 211 receives new entries from the processing module 240 and may also send entries for use in the processing module. These entries may be sent and received over a network 260, in some embodiments this may be over the internet via a RESTful API which in this embodiment may form a client terminal, it should be noted that the invention is not limited to this a mobile terminal may send requests in an alternate embodiment. Although FIG. 2 details a single storage module 210 the invention is not limited to this embodiment, there may be multiple instances of storage modules 210 containing the global ledger 211 included in the system for redundancy.

The processing module 240 generates keys from new data entries from clients in a client group 250 and previous keys retrieved from the global ledger 211 in the storage module 210.

In some embodiments, the method in which the keys, referred to as a hash in these embodiments, may be generated from the data is to use a cryptographic hashing algorithm. The input to this algorithm consists of the data hash of the current entry and the hash generated from the previous data entry. The hashing algorithm applies a formula to the inputs so that a hash of a fixed size which represents the original data is generated. The algorithm is a one-way function meaning it is computationally infeasible to invert the process and calculate the input from the hash. However, should the user have access to the original input data, verification of the hash can be carried out by re-computing and matching the hash values against each other. The hash generated by the algorithm must change substantially with any small change in the original data so the output of the slightly changed data appears to be uncorrelated with the output of the original data. The intricacies of cryptographic hashing algorithms will not be disclosed as they are considered to be part of the general knowledge to a person skilled in the art.

According to other embodiments, the method in which the keys of the data may be generated is a block cipher. A block cipher allows for the data to be encrypted by the use of a cipher combined with the previous ciphertext to link each new data entry to all previous data entries.

The specific key generating methods described in the embodiments above may be used, however the process is not limited to those methods described and any suitable method of generating a key from current data and a past key may form an alternate embodiment.

Once a key is generated from the new data and a previous key it is stored in the global ledger 211 and transmitted back to the client group 250 from which it originated and is stored in the client ledger 220 and relevant asset ledger 230.

The processing module 240 is in charge of directing the newly generated keys to the correct client group 250 where they are required. The entry has been validated once all client ledgers 220 at the client group 250 match.

In one embodiment the storage module 210 and the processing module 240 may be realised on, but are not limited to, an individual hardware device or a distributed system such as a cloud computing service, with the processing module implemented on hardware, and/or software.

There are a number of client groups 250 on the system that may also send new data entries to the processing module 240 to be processed and included in the global ledger 211.

Although the embodiment detailed in FIG. 2 shows two client groups 250 in the system 200 it should be noted that the invention is not limited to this embodiment and that there is no upper limit to the number of client groups 250 which may be connected to the system and that the number may alter over time as client groups 250 are added or removed from system 200.

The embodiment detailed in FIG. 2 may show only one or two client ledgers 220 present in each client group 250, however this is for simplicity in the drawing, the client ledger 220 may be replicated multiple times within a specific Client group 250 with no upper bound.

The same also applies to the asset ledger 230, although one or two are shown for each client ledger 220 the invention is not limited as such, there may be any number of documents upwards of one attributed to each client ledger 220.

The client ledgers 220 and asset ledgers 230 are remotely stored and operated at each client group 250 and may connect to the processing module 240 through a RESTful API which in one embodiment may form a client terminal, it should he noted that the invention is not limited to this a mobile terminal may send requests in an alternate embodiment.

A client ledger 220 can he removed from a client group 250 with no effect to the other client ledgers 220 in said client group 250. A new client ledger 220 can also be added to a client group 250 where it will retrieve the data from existing client ledgers 220 in said client group 250.

Once added to the client ledger 220 the change will also be made to the relevant asset ledger 230.

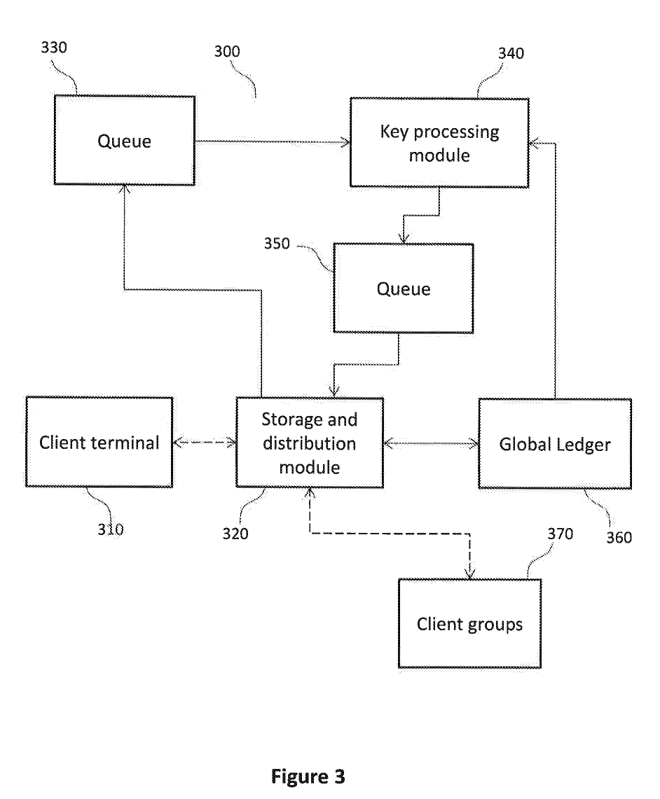

FIG. 3 details one embodiment of the system 300 in the form of a network diagram in which the method of creating an immutable data entry can be seen. In the present embodiment the network comprises of: a Client terminal 310, a storage and distribution module 320, a first queue 330, a key processing module 340, a second queue 350, a global ledger 360 and client groups 370.

The embodiment initialises with the addition of a data file to a client terminal 310, the client terminal may be in one embodiment a desktop computer but is not limited to that further embodiments may be in the form of a mobile device. The data entry may consist of information pertaining to but not limited to medical trials, records of insurance or legal documents.

Once added to a client terminal 310, the data entry is not yet verified and immutable. The data entry is transmitted to the storage and distribution module 320 which identifies that it is a new data entry and adds it to the queue 330. The queue 330 may be of a first in first out (FIFO) configuration but is not limited as such; it may also have the configuration of a first in last out (FIFO) or a priority queue among other types, as would be apparent to a person skilled in the art.

The key processing module 340 reads in the next data entry from the queue 330 along with the relevant keys stored in the global ledger 360. The combination of these parameters is used to generate the new set of keys for the current data entry.

In some embodiments the method in which the keys, referred to as a hash in these embodiments, may be generated from the data is to use a cryptographic hashing algorithm. The input to this algorithm consists of the data hash of the current entry and the hash generated from the previous data entry. The hashing algorithm applies a formula to the inputs so that a hash of a fixed size which represents the original data is generated. The algorithm is a one-way function meaning it is computationally infeasible to invert the process and calculate the input from the hash. However, should the user have access to the original input data, verification of the hash can be carried out by re-computing and matching the two hash values against each other. The hash generated by the algorithm must change substantially with any small change in the original data so the output of the slightly changed data appears to be uncorrelated with the output of the original data. The intricacies of cryptographic hashing algorithms will not be disclosed as they are considered to be part of the general knowledge to a person skilled in the art.

According to other embodiments, the method in which the keys of the data may be generated is a block cipher. A block cipher allows for the data to be encrypted by the use of a cipher combined with the previous ciphertext to link each new data entry to all previous data entries.

The specific key generating methods described in the embodiments above may be used, however the process is not limited to those methods described and any suitable method of generating a key from current data and a past key may form an alternate embodiment.

The newly generated keys are sent to the second queue 350. The queue 350 may be of a first in first out (FIFO) configuration but is not limited as such; it may also have the configuration of a first in last out (FILO) or a priority queue among other types, as would be apparent to a person skilled in the art. The storage and distribution module 320 then reads in the next set of keys from the queue 350, so that they can be added to the global ledger 360 and in all client ledgers and asset ledgers in the client groups 370 where they are required. The storage and distribution module 320 keeps track of this information.

Once the data entry is verified on the client ledgers in the relevant client group 370 a message may be displayed on the client terminal 310 stating that the data has successfully been added to the split distributed ledger.

The storage and distribution module 320 can communicate with all client groups 370 registered in the system so to accept and queue any incoming additional data entry from any client terminal 310.

The client terminals 310 are stored remotely and may interact with the storage and distribution module 320 over a RESTful API. The storage and distribution module 320, key processing module 340, global ledger 360 and queues 330 and 350 may be stored on the same hardware but are not limited to this configuration; they may also be formed out of a cloud computing service.

The storage and distribution module 320 may also allow for methods to be run where the client ledgers from client groups 370 are checked against the global ledger 360 to ensure that all the data in the ledgers is valid.

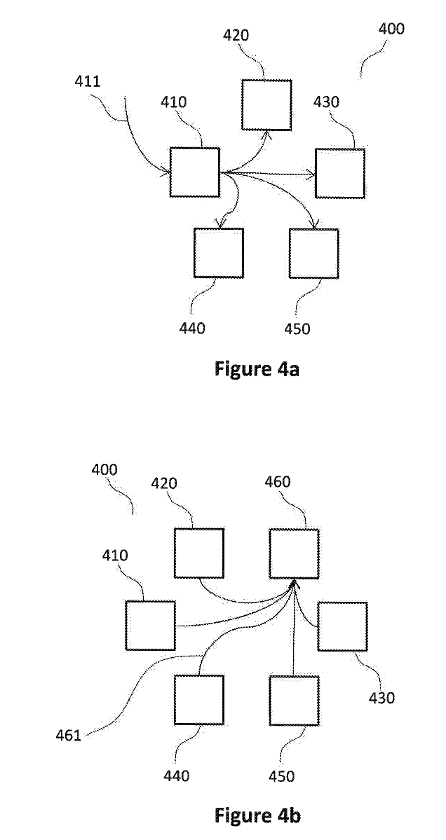

FIGS. 4a and 4b detail the processes of a new data entry and a new node being added to a client group 400 according to some embodiment. The embodiment detailed in FIG. 4a Shows that when a new data entry 411 is added and verified to a node 410 in a client group 400, it is disseminated to all other nodes 420-450 in the client group 400. According to another embodiment, agnostic or simultaneous broadcasting may be utilised, in these embodiment the data entry will be received on all nodes 410 to 450 at the same instance in time.

The embodiment detailed in FIG. 4b shows the addition of a new node 460 to the client group 400, on addition to the client group 400 all data 461 is replicated and verified on the new node 460 so that it is in the same state as the other nodes 410-150 in the client group. According to another embodiment the data may be replicated on the new node 460 from a single master node, for example node 410 in this case, and all future added nodes would receive the data from this master node.

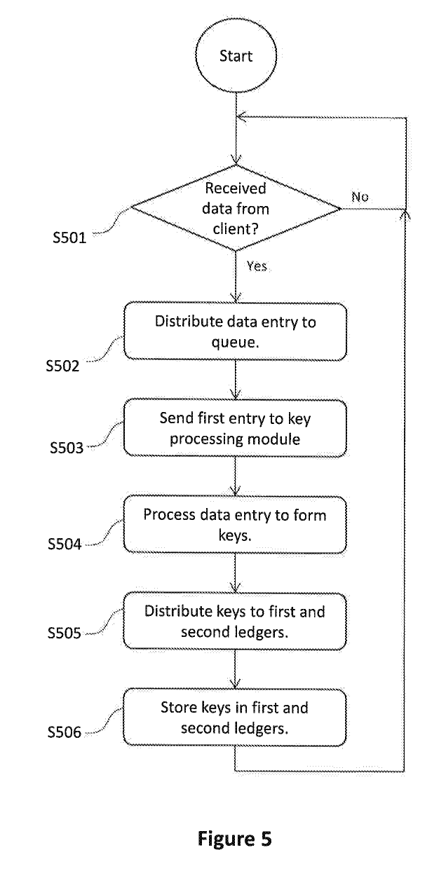

FIG. 5 details a flowchart showing the steps of one method according to one embodiment in which keys can be stored in the ledgers as implemented by the embodiments of the systems 200 and 300 detailed in FIG. 2 and FIG. 3. It should be noted that in other embodiments, if desired, one or more of the different steps detailed in the flowchart may be optional. Additionally if desired the steps may be executed in an alternative sequences or concurrently with each other.

For the sake of clarity the description of FIG. 5 will also include reference numerals of the embodiment detailed in FIG. 3 but it should be noted that the method also applies to the embodiment detailed in FIG. 2.

New data entries to the processing module from a client terminal 310 are detected in step 501. The following step, step 502, utilises the distribution and storage module 350 to send the data entry from the client group 320 to the queue 330 for the key processing module 340. The data entry is then dequeued and moved into the key processing module 340 so that keys can be generated by the contents of the data in steps 503 and 504. Once the keys have been generated from the data, they must be sent to the relevant nodes in the system by the storage and distribution module 350 this is performed in step 505. The final step, step 506, consists of storing the keys in the first ledger 360 and second ledgers in the client group 320. The system then returns to a state of waiting for a new data entry to be entered by the client, step 501.

Whilst specific embodiments of the invention have been described, the scope of the invention is defined by the appended claims and not limited to the embodiments described. The invention could therefore by implemented in other ways, as would be appreciated by a person skilled in the art.

1. A system for processing information, comprising:
a storage module for hosting a first ledger, and a processing module, wherein the processing module is configured to:
receive a data entry from a client stored remotely of the processing module,
process the data entry to form one or more keys relating to the data entry,
wherein the processing module is configured to compute the one or more keys for the received data entry using the received data entry and the key of a previously received data entry: and
store the one or more keys in the first ledger and distribute the one or more keys to a second ledger stored remotely of the storage module.

2. The system according to claim 1, wherein the storage module is arranged to store one instance of the first ledger, which is a global ledger, and the processing module is further configured to receive data from a plurality of instances of the second ledger, which are client ledgers.

3. The system according to claim 2, wherein the plurality of client ledgers are categorized into sets dependent on a client.

4. The system according to claim 3, wherein the processing module is further arranged to access a plurality of a third category of ledger hosted remotely of the storage module, wherein
the third category of ledger is an asset ledger utilized for version tracking of the data entry.

5. The system according to claim 3, wherein the processing module is arranged to replicate the client and asset ledgers on a plurality of nodes associated with the client.

6. The system according to claim 5, wherein the global ledger is accessible to every node in the plurality of nodes.

7. The system according to claim 3, wherein the processing module is arranged to add a data entry to one client ledger in the plurality of client ledgers.

8. The system according to claim 3, wherein the processing module is arranged to generate the one or more keys by a cryptographic hashing algorithm and to verify the process at all client ledgers in the set.

9. The system according to claim 8, wherein the cryptographic hashing algorithm computes the one or more keys as a hash values from a combination of the received data entry and the previously generated hash values.

10. The system according to claim 1, wherein upon the identification of a corrupted client ledger, the processing module is arranged to reconstruct said corrupted client ledger from an uncorrupted client ledger in the same set.

11. A method of processing information, comprising:
hosting a first ledger;
receiving a data entry from a client;
processing of data to form one or more keys; and
storing the one or more keys in the first ledger and distributing the one or more keys to a second ledger hosted remotely.

12. The method according to claim 11, wherein the processing of the data uses a cryptographic hashing algorithm that utilizes the received data entry and previously generated keys as inputs.
